(19) United States
(12) Patent Application Publication
(10) Pub. No.: US 2025/0353162 A1
(43) Pub. Date: Nov. 20, 2025

(54) Screw Assembly and Disassembly Tool

(71) Applicant: Yantai Greenery Tools Co., Ltd., Yantai (CN)

(72) Inventors: Changlei FAN, Yantai (CN); Bo YU, Yantai (CN); Caiyun YAO, Yantai (CN)

(21) Appl. No.: 19/201,885

(22) Filed: May 7, 2025

(30) Foreign Application Priority Data
May 17, 2024 (CN) 202421083511.X

(51) Int. Cl. B25G 1/00; B25G 1/08

(52) U.S. Cl. CPC B25G 1/005; B25G 1/085

(57) ABSTRACT

A screw assembly and disassembly tool includes a handle, a first working portion and an operating portion; the first working portion is connected with the handle, an end of the first working portion is configured to cooperate with a slot of a screw head; the operating portion has an operation state and a stowed state, the operating portion includes a first operating lever connected with a side of the handle, the first operating lever is able to rotate at least between a first position and a second position; in the operation state, the first operating lever is located at the first position, the first operating lever is rotated to drive the first working portion to rotate; when the operating portion is turned from the operation state to the stowed state, the first operating lever is rotated from the first position towards the handle, and rotated to the second position.

### CROSS-REFERENCE TO RELATED APPLICATIONS

This application claims priority to Chinese Patent Application No. 202421083511.X, filed on May 17, 2024, which is incorporated herein by reference in its entirety.

### TECHNICAL FIELD

Embodiments of the present disclosure relate to the technical field of screw assembly and disassembly, and in particular, to a screw assembly and disassembly tool.

### BACKGROUND

A screw is a metal product used for fixing or connecting a body, and is generally in a spiral shape.

A head of a screw usually has a slot, which is typically a straight slot, a cross slot, or a hexagonal slot. When using screws to fix or connect objects, corresponding disassembly and assembly tools are required, such as a flathead screwdriver, a Phillips screwdriver, or a hex key. There are various forms of hex keys, such as a T-shaped hex key. The T-shaped hex key generally includes a handle and a hexagon wrench. The hexagon wrench is fixedly connected with the handle, and the hexagon wrench cooperates with the handle to form a T-shaped structure. When a user is using the T-shaped hex key, the user grips the handle and rotates the handle around a lengthwise direction of the hexagon wrench, thereby driving the hexagon wrench to rotate, so as to tighten or loosen the screw.

However, a method of using a T-shaped hex key by gripping and operating the handle to drive the hexagon wrench for disassembling and assembling screws is not convenient enough and has relatively low efficiency.

### SUMMARY

Provided in an embodiment of the present disclosure is a screw assembly and disassembly tool, which is used for solving the technical problem that the method of using a T-handle hex key by gripping and operating the handle to drive the hex key for disassembling and assembling screws is not convenient enough and has relatively low efficiency.

In order to solve the technical problem, the embodiments of the present disclosure provide the following technical solutions:

An embodiment of the present disclosure provides a screw assembly and disassembly tool. The screw assembly and disassembly tool comprises a handle, a first working portion and an operating portion; wherein
the first working portion is connected with the handle, and an end of the first working portion away from the handle is configured to cooperate with a slot of a screw head;
the operating portion is configured to have an operation state and a stowed state, the operating portion comprises a first operating lever, the first operating lever is connected with a side of the handle away from the first working portion, and the first operating lever is able to rotate at least between a first position and a second position;
the operating portion is configured such that in the operation state, the first operating lever is located at the first position, and the first operating lever is rotated to drive the first working portion to rotate; and when the operating portion is turned from the operation state to the stowed state, the first operating lever is rotated from the first position towards the handle, and is rotated to the second position.

The beneficial effects of the embodiments of the present disclosure are as follows: the screw assembly and disassembly tool provided in the embodiments of the present disclosure includes a handle, a first working portion and an operating portion; in an initial stage of loosening the screws or a final stage of tightening the screws, a required force is relatively large, and in this case, the user is able to grip the handle and apply a force to loosen or tighten screws; after the screws are loosened in the initial stage, the force required for disassembling the screws is small, and in this case, the first operating lever is rotated to the first position, the operating portion is in an operation state, and in this case, the first operating lever is rotated to drive the first working portion to rotate, so that the screws are able to be quickly disassembled, improving the disassembly efficiency of screws. Likewise, during the initial stage of assembling screws, less force is required to rotate the screw, in this case, the first operating lever is able to be rotated to the first position. By twisting the first operating lever, the first working portion is driven to rotate, which allows for rapid tightening of the screws and improves the efficiency of screw tightening. In the final stage of screw tightening, more force is needed, in this case, the first operating lever is rotated to the second position, placing operating portion in a stowed state, enabling the user to grip the handle and apply a force to tighten the screw. In other words, a design of the operating portion allows the user to quickly and conveniently tighten or loosen screws, enhancing the efficiency of screw tightening or loosening. Furthermore, when the first operating lever is rotated to the second position, the first operating lever deflects to one side, so that when the user grips the handle, an end of the first operating lever away from its rotation connection point with the handle does not abut against the user's palm of the hand, thereby improving the comfort level when the user grips the handle.

In an implementation, when the first operating lever is rotated to the first position, a lengthwise direction of the first operating lever is the same as an axial direction of the first working portion;
when the first operating lever is rotated to the second position, an angle between the lengthwise direction of the first operating lever and the axial direction of the first working portion is 45° to 150°.

In an implementation, the side of the handle away from the first working portion is provided with a receiving groove;
a first end of the first operating lever is rotatably connected with a side wall of the receiving groove, and when the first operating lever is rotated to the second position, the first operating lever is recessed into the receiving groove.

In an embodiment, the receiving groove includes a transverse groove and a longitudinal groove communicating with each other, the transverse groove and the longitudinal groove form a T-shaped structure, and the longitudinal groove extends in the lengthwise direction of the handle;
the first operating lever includes a connecting edge and an operating edge which are connected with each other; the operating edge and the connecting edge form a T-shaped structure; and the connecting edge is located inside the transverse groove and is rotatably connected with a side wall of the transverse groove;
when the first operating lever is rotated to the second position, the operating edge is rotated into the longitudinal groove; and
the lengthwise direction of the first operating lever is a lengthwise direction of the operating edge.

In an embodiment, a side surface of the operating edge is provided with an anti-slip structure.

In an implementation, in a circumferential direction of the lengthwise direction of the operating edge, a plurality of raised ridges are arranged at intervals on the side surface of the operating edge, and the plurality of raised ridges form the anti-slip structure.

In an implementation, the side of the handle away from the first working portion is provided with a avoidance groove communicating with the receiving groove; and the avoidance groove is located at an end portion of the receiving groove away from its rotation connection point with the first operating lever; the avoidance groove is configured such that when the first operating lever is rotated into the receiving groove, the avoidance groove provides space for the finger of a user, allowing the user to pry the first operating lever out of the receiving groove.

In an embodiment, an end surface of a second end of the first operating lever is provided with a finger-grip protrusion, and the second end of the first operating lever and the first end of the first operating lever are opposite ends of the first operating lever.

In an implementation, a bottom surface of the avoidance groove is an inclined plane, and the inclined plane inclines towards a bottom of the receiving groove.

In an implementation, an end of the inclined plane close to the receiving groove is located in a middle of the side wall of the receiving groove;
the inclined plane forms an angle of 45°-85° with respect to a plane in which the side wall of the receiving groove is located.

In an implementation, the operating portion further includes a second operating lever, the second operating lever is connected with the side of the handle away from the first working portion, and the second operating lever is rotatable at least between a third position and a fourth position;
the operating portion is configured such that in the operation state, the second operating lever is located at the third position, and the first operating lever and the second operating lever are rotated to drive the first working portion to rotate; when the operating portion is rotated from the operation state to the stowed state, the second operating lever is rotated from the third position towards the handle, and is rotated to the fourth position, and a direction in which the first operating lever rotates from the first position to the second position is different from a direction in which the second operating lever is rotated from the third position to the fourth position.

In an implementation, when the second operating lever is rotated to the third position, a lengthwise direction of the second operating lever is the same as an axial direction of the first working portion;
when the second operating lever is rotated to the second position, an angle between the lengthwise direction of the second operating lever and the axial direction of the first working portion is 45° to 150°.

In an implementation, when the first operating lever is located at the first position and the second operating lever is located at the third position, the first operating lever is attached to the second operating lever.

In an implementation, the side of the handle away from the first working portion is provided with a receiving groove;
a first end of the first operating lever is rotatably connected with a side wall of a middle portion of the receiving groove in a lengthwise direction, and when the first operating lever is rotated to the second position, the first operating lever is recessed into the receiving groove located on the side of the first operating lever away from the second operating lever;
a first end of the second operating lever is rotatably connected with a side wall of the middle portion of the receiving groove in the lengthwise direction, and when the second operating lever is rotated to the fourth position, the second operating lever is recessed into the receiving groove located on a side of the second operating lever away from the first operating lever.

In an implementation, the screw assembly and disassembly tool further includes a second working portion, the second working portion is connected with the handle, the second working portion extends out from an end of the handle in the lengthwise direction, and an end of the second working portion extending out of the handle is configured to cooperate with a slot of a screw head.

In an implementation, a length of a part of the second working portion extending out of the handle is less than a length of a part of the first working portion extending out of the handle.

In addition to the technical problems solved by the embodiments of the present disclosure, the technical features constituting the technical solutions, and the beneficial effects brought about by the technical features of these technical solutions as described above, other technical problems that can be solved by the screw assembly and disassembly tool provided in the present disclosure, other technical features included in the technical solutions, and beneficial effects brought about by these technical features will be further described in detail in the specific embodiments.

### BRIEF DESCRIPTION OF THE DRAWINGS

Accompanying drawings herein are incorporated into the specification and constitute into a part of the specification, show examples consistent with the present disclosure, and are used to explain principles of the present disclosure with the specification.

FIG. 1 is a schematic diagram of a first operating lever of a screw assembly and disassembly tool in a first position according to an embodiment of the present disclosure;

FIG. 2 is a schematic diagram of a first operating lever of a screw assembly and disassembly tool in a second position according to an embodiment of the present disclosure;

FIG. 3 is a schematic diagram of a screw assembly and disassembly tool without a first operating lever according to an embodiment of the present disclosure.

FIG. 4 is a schematic diagram of a first operating lever according to an embodiment of the present disclosure;

FIG. 5 is a schematic diagram of an operating portion in an operation state according to an embodiment of the present disclosure.

### DETAILED DESCRIPTION OF THE EMBODIMENTS

Hereinafter, the technical solutions in the embodiments of the present disclosure will be described clearly and thoroughly with reference to the accompanying drawings of the embodiments of the present disclosure. Obviously, the embodiments as described are only some of the embodiments of the present disclosure, and are not all of the embodiments of the present disclosure. All other embodiments obtained by a person of ordinary skill in the art on the basis of the embodiments of the present disclosure without any inventive effort shall all fall within the scope of protection of some embodiments of the present disclosure.

### Embodiment I

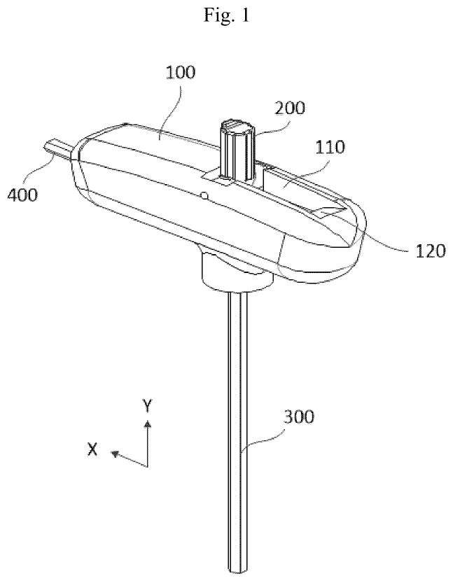

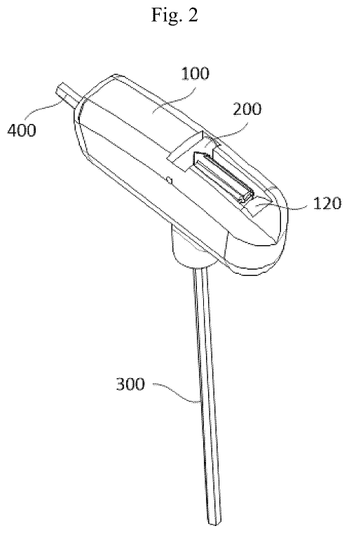

As shown in FIGS. 1 and 2, a screw assembly and disassembly tool provided in the present embodiment includes a handle 100, a first working portion 300 and an operating portion. The first working portion 300 is connected with the handle 100, and an end of the first working portion 300 away from the handle 100 is configured to be fitted with a slot of a screw head, that is to say, the first working portion 300 is configured to be fitted with the slot of the screw head, so that the screw assembly and disassembly tool is able to tighten or loosen screws. Exemplarily, a structure at the end of the first working portion 300 away from the handle 100 is able to be a flat-head structure, a Phillips structure, a star structure, a hex flathead structure, or a hex roundhead structure, that is to say, the first working portion 300 is able to be a flat-head screwdriver head, a Phillips screwdriver head, a star screwdriver head, a hexagonal flat-head screwdriver head, or a hexagonal round-head screwdriver head, etc.

Exemplarily, the first working portion 300 is combined with the handle 100 to form a T-shaped structure or an L-shaped structure.

In the present embodiment, the operating portion is configured to have an operation state and a stowed state, the operating portion includes a first operating lever 200, the first operating lever 200 is connected with a side of the handle 100 away from the first working portion 300, and the first operating lever 200 is able to rotate at least between a first position and a second position; that is, the first lever 200 is able to be rotated from the first position to the second position, or is able to be rotated from the second position to the first position, and when the first operating lever 200 is rotated from the first position to the second position, the first operating lever 200 is further able to continue to rotate forwards; a first limiting mechanism (exemplarily, the first limiting mechanism is able to be a side wall of the receiving groove 110 described below) is able to be provided to prevent the first operating lever 200 from further rotating forwards, and likewise, when the first operating lever 200 is rotated from the second position to the first position, the first operating lever 200 is able to continue to rotate forwards, and a second limiting mechanism (for example, the second limiting mechanism is able to be a bottom surface of the receiving groove 110 described below) is also able to be provided to prevent the first operating lever 200 from further rotating forwards. Whether the first operating lever 200 continues to rotate after being rotated from the first position to the second position, and whether the first operating lever 200 continues to rotate after being rotated from the second position to the first position are not specifically limited herein.

In the present embodiment, the operating portion is configured such that in the operation state, the first operating lever 200 is located at the first position, and the first operating lever 200 is rotated to drive the first working portion 300 to rotate; when the operating portion is turned from the operation state to the stowed state, the first operating lever 200 is rotated from the first position towards the handle 100, and is rotated to the second position. That is to say, when the operating portion is in the stowed state, the first operating lever 200 is located at the second position, and at this time, the user is able to grip the handle 100 and apply a force to loosen or tighten the screw. When the first operating lever 200 is rotated to the second position, the first operating lever 200 deflects to one side, such that when the user grips the handle 100, an end of the first operating lever 200 away from the rotation connection with the handle 100 does not abut against the user's palm of the hand, thus improving the comfort level when the user grips the handle 100.

During a use of the screw assembly and disassembly tool provided in the present embodiment, since in an initial stage of loosening the screws or a final stage of tightening the screws, a required force is relatively large, and in this case, the user is able to grip the handle 100 and apply a force to loosen or tighten screws; after the screws are loosened in the initial stage, the force required for disassembling the screws is small, and in this case, the first operating lever 200 is rotated to the first position, the operating portion is in the operation state, and in this case, the first operating lever 200 is twisted to drive the first working portion 300 to rotate, so that the screws are able to be quickly disassembled, improving the disassembly efficiency of screws. Likewise, during the initial stage of assembling screws, less force is required to rotate the screw, in this case, the first operating lever 200 is able to be rotated to the first position. By twisting the first operating lever 200, the first working portion 300 is driven to rotate, which allows for rapid tightening of the screws and improves the efficiency of screw tightening. In the final stage of screw tightening, more force is needed, in this case, the first operating lever 200 is rotated to the second position, placing operating portion in the stowed state, enabling the user to grip the handle 100 and apply a force to tighten the screw. A design of the first operating lever 200 allows the user to quickly and conveniently tighten or loosen screws, enhancing the efficiency of screw tightening or loosening.

In some embodiments of the present disclosure, when the first operating lever 200 is rotated to the first position, a lengthwise direction of the first operating lever 200 is the same as an axial direction of the first working portion 300 (e.g., the Y direction in FIG. 1); when the first operating lever 200 is rotated to the second position, an angle between the lengthwise direction of the first operating lever 200 and the axial direction of the first working portion 300 is 45° to 150°, exemplarily, when the first operating lever 200 is rotated to the second position, the angle between the lengthwise direction of the first operating lever 200 and the axial direction of the first working portion 300 is 45°, 60°, 80°, 90°, 100° or 150°. That is to say, when the first operating lever 200 is rotated to the first position, the angle between the lengthwise direction of the first operating lever 200 and the axial direction of the first working portion 300 is 0°; when the first operating lever 200 is rotated to the second position, the first operating lever 200 rotates clockwise or counterclockwise. The first operating lever 200 rotates in a direction close to the handle 100, thus, the first operating lever 200 is vertical and is deflected and tilted to one side, so that when the user grips the handle 100, the end of the first operating lever 200 away from its rotation connection point with the handle 100 does not abut against the user's palm of the hand, thereby improving the comfort level when the user grips the handle 100.

It should be noted that, the lengthwise direction of the first operating lever 200 being the same as the axial direction of the first working portion 300 refers to that the lengthwise direction of the first operating lever 200 and the axial direction of the first working portion 300 are in a same direction; the lengthwise direction of the first operating lever 200 is parallel to the axial direction of the first working portion 300, and it is defined to have a same orientation; that is to say, if it is defined that the end of the first working portion 300 away from the handle 100 points to an end of the first working portion 300 where the handle 100 is connected with, then, the lengthwise direction of the first operating lever 200 is that the end of the first operating lever 200 rotatably connected with the handle 100 points to the end of the first operating lever 200 away from the handle 100.

As shown in FIGS. 1, 2 and 3, in some embodiments of the present disclosure, an receiving groove 110 is provided on the side of the handle 100 away from the first working portion 300. A first end of the first operating lever 200 is rotatably connected with a side wall of the receiving groove 110, and when the first operating lever 200 is rotated to the second position, the first operating lever 200 is recessed into the receiving groove 110. That is to say, as shown in FIG. 1, when the first operating lever 200 is rotated to the first position, the first operating lever 200 is vertically upward, i.e. the lengthwise direction of the first operating lever 200 is the same as the axial direction of the first working portion 300; as shown in FIG. 2, when the first operating lever 200 is rotated to the second position, the first operating lever 200 is rotated to one side and is rotated into the receiving groove 110, so that when the user grips the handle 100, the first operating lever 200 does not interfere with the user's grip on the handle 100, thereby improving the comfort when the user grips the handle 100.

Exemplarily, when the first operating lever 200 is sunk into the receiving groove 110 and the first operating lever 200 is rotated to the second position, the angle between the lengthwise direction of the first operating lever 200 and the axial direction of the first working portion 300 is about 90° C.

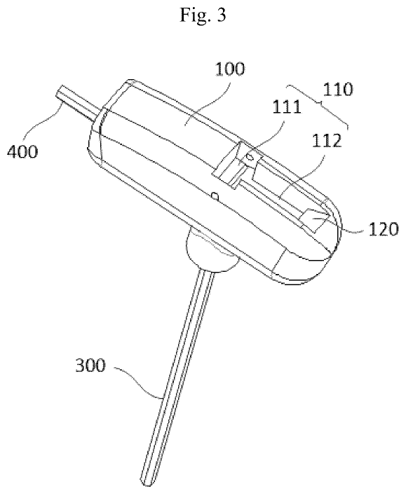

It should be noted that, the receiving groove 110 in the embodiment of the present disclosure is not limited to the structure in FIG. 3, and may also be based on the structure shown in FIG. 3, the receiving groove 110 extends to a left side, that is to say, the first end of the first operating lever 200 is rotatably connected with a side wall in a middle of the receiving groove 110; when the first operating lever 200 is in a vertical state, the first operating lever 200 is located at the first position, i.e. the operating portion is in the operation state; the first operating lever 200 is able to rotate to the right from the first position, until it is recessed into the receiving groove 110 which is on a right side of the position where the first operating lever 200 is rotatably connected with the side wall of the receiving groove 110. The first operating lever 200 may also be rotated leftwards from the first position, until it is recessed into the receiving groove 110 which is on a left side of the position where the first operating lever 200 is rotatably connected with the side wall of the receiving groove 110; and the second position may be a position where the first operating lever 200 is rotated rightwards and is recessed into the receiving groove 110, and may also be a position where the first operating lever 200 is rotated leftwards and is recessed into the receiving groove 110.

As shown in FIGS. 2, 3 and 4, in some embodiments of the present disclosure, the receiving groove 110 includes a transverse groove 111 and a longitudinal groove 112 which communicate with each other; the transverse groove 111 and the longitudinal groove 112 form a T-shaped structure; and the longitudinal groove 112 extends in the lengthwise direction of the handle 100 (the X direction in FIG. 1). The first operating lever 200 includes a connecting edge 210 and an operating edge 220 which are connected; the operating edge 220 and the connecting edge 210 form a T-shaped structure; and the connecting edge 210 is located in the transverse groove 111 and is rotatably connected with a side wall of the transverse groove 111. When the first operating lever 200 is rotated to the second position, the operating edge 220 is rotated into the longitudinal groove 112. In the present embodiment, the lengthwise direction of the first operating lever 200 is a lengthwise direction of the operating edge.

In order to avoid a slip when rotating the operating edge 220, a side surface of the operating edge 220 is provided with an anti-slip structure. Exemplarily, in a circumferential direction of the lengthwise direction of the operating edge, a plurality of raised ridges are arranged at intervals on the side surface of the operating edge 220, and the plurality of raised ridges form the anti-slip structure. Of course, the anti-slip structure may also be other structures, which are not specifically limited herein.

In some embodiments of the present disclosure, in order to facilitate the rotation out of the first operating lever 200 that rotates into the receiving groove 110, the side of the handle 100 away from the first working portion 300 is provided with an avoidance groove communicating with the receiving groove 110; and the avoidance groove is located at an end portion of the receiving groove 110 away from its rotation connection point with the first operating lever 200; the avoidance groove is configured such that when the first operating lever 200 is rotated into the receiving groove 110, the avoidance groove provides a space for the finger of a user, allowing the user to pry the first operating lever 200 out of the receiving groove 110. That is to say, the avoidance groove provides space for the user to insert their finger to pry the first operating rod 200, facilitating the user prying the first operating rod 200 out of the receiving groove 110.

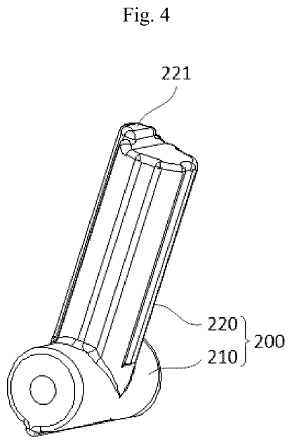

As shown in FIG. 4, in some embodiments of the present disclosure, in order to facilitate a user lifting out the first operating rod 200 from the receiving groove 110, an end surface of a second end of the first operating lever 200 is provided with a finger-grip protrusion 221, and the second end of the first operating lever 200 and the first end of the first operating lever 200 are opposite ends of the first operating lever 200.

In some embodiments of the present disclosure, the bottom surface of the avoidance groove is an inclined plane 120, and the inclined plane 120 is inclined towards a bottom of the receiving groove 110. Exemplarily, the end of the inclined plane 120 close to the receiving groove 110 is located in a middle of the side wall of the receiving groove 110; and the angle between the inclined plane 120 and a plane where the side wall of the receiving groove 110 is located is 45° to 85°.

As shown in FIGS. 1 and 2, in some embodiments of the present disclosure, the screw assembly and disassembly tool further includes a second working portion 400; the second working portion 400 is connected with the handle 100; the second working portion 400 extends out from an end of the handle 100 in the lengthwise direction; and an end of the second working portion 400 extends out of the handle 100 is configured to cooperate with a slot of a screw head. The provision of the second working portion 400 makes the use of the screw assembly and disassembly tool more flexible. Exemplarily, a length of a part of the second working portion 400 extending out of the handle 100 is less than a length of a part of the first working portion 300 extending out of the handle 100. A relatively shorter length of the second working portion 400 protruding from the handle 100 allows for the application of greater force, which enables the screw to be tightened more securely, and makes it easier to loosen the screw at the initial stage of operation.

In some embodiments of the present disclosure, exemplarily, the structure of the end of the first working portion 300 away from the handle 100 is different from the structure of the end of the second working portion 400 away from the handle 100. Exemplarily, the end of the first working portion 300 away from the handle 100 is a Phillips structure; the end of the second working portion 400 away from the handle 100 is a hex flathead structure, or the end of the first working portion 300 away from the handle 100 is a hex roundhead structure; the end of the second working portion 400 away from the handle 100 is a hex flathead structure; certainly, the structure of the end of the first working portion 300 away from the handle 100 may also be the same as the structure of the end of the second working portion 400 away from the handle 100.

### Embodiment II

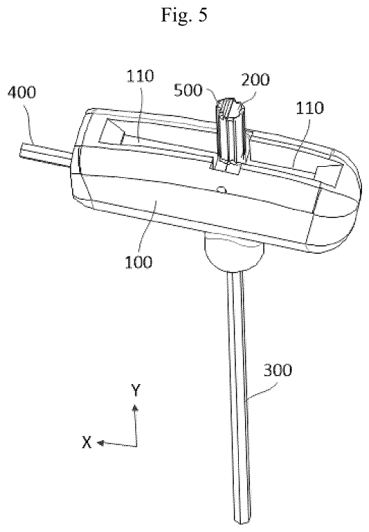

As shown in FIG. 5, in the present embodiment, the operating portion includes a first operating lever 200 and a second operating lever 500; the first operating lever 200 is connected with the side of the handle 100 away from the first working portion 300, and the first operating lever 200 is able to rotate at least between a first position and a second position. The second operating lever 500 is connected with the side of the handle 100 away from the first working portion 300, and the second operating lever 500 is rotatable at least between a third position and a fourth position. The operating portion is configured such that in an operation state, the first operating lever 200 is located at the first position, the second operating lever 500 is located at the third position, and the first operating lever 200 and the second operating lever 500 are rotated to drive the first working portion 300 to rotate; when the operating portion is rotated from the operation state to a stowed state, the second operating lever 500 is rotated from the third position towards the handle 100, and is rotated to the fourth position, and a direction in which the first operating lever 200 is rotated from the first position to the second position is different from a direction in which the second operating lever 500 is rotated from the third position to the fourth position. That is, as shown in FIG. 5, when the operating portion is in the operation state, the first operating lever 200 is located at the first position, the second operating lever 500 is located at the third position, and the first operating lever 200 and the second operating lever 500 serve as operating parts of the screw assembly and disassembly tool; when the force required for disassembling and assembling the screw is relatively small, the operating portion is able to be rotated to drive the first working portion 300 to rotate; in an initial stage of loosening the screws or a final stage of tightening the screws, a required force for disassembling and assembling the screw is relatively large, in this case, the first operating lever 200 is rotated to the second position, and the second operating lever 500 is rotated to the fourth position, and thus, the first operating lever 200 and the second operating lever 500 are deflected to two sides, and the user grips the handle 100 and applies a force to tighten the screw, which increases the comfort of the user when gripping the handle 100.

In some embodiments, when the second operating lever 500 is rotated to the third position, an lengthwise direction of the second operating lever 500 is the same as an axial direction of the first working portion 300, that is to say, when the operating portion is in the operation state, the first operating lever 200 is located at the first position, and the second operating lever 500 is located at the second position; the lengthwise direction (e.g., Y direction in FIG. 5) of the first operating lever 200 is the same as the lengthwise direction (e.g., Y direction in FIG. 5) of the second operating lever 500; and this arrangement facilitates the user to quickly twist the first operating lever 200 and the second operating lever 500, improving the efficiency of disassembling and assembling screws. When the second operating lever 500 is rotated to the second position, an angle between the lengthwise direction of the second operating lever 500 and the axial direction of the first working portion 300 is 45° to 150°. Exemplarily, when the second operating lever 500 is rotated to the fourth position, the angle between the lengthwise direction of the second operating lever 500 and the axial direction of the first working portion 300 is 45°, 60°, 80°, 90°, 100° or 150°. That is to say, when the second operating lever 500 is rotated to the fourth position, the angle between the lengthwise direction of the second operating lever 500 and the axial direction of the first working portion 300 is 0°; when the second operating lever 500 is rotated to the fourth position, the second operating lever 500 is rotated in a direction away from the first operating lever 200, thus, the second operating lever 500 is vertical and is deflected and tilted to one side, so that when the user grips the handle 100, the end of the first operating lever 200 away from its rotation connection point with the handle 100 does not abut against the user's palm of the hand, thereby improving the comfort level when the user grips the handle 100.

During a use of the screw assembly and disassembly tool provided in the present embodiment, in the initial stage of loosening the screws or the final stage of tightening the screws, the user is able to grip the handle 100 and apply a force to loosen or tighten screws; after the screws are loosened in the initial stage, the force required for disassembling the screws is small, and in this case, the first operating lever 200 is rotated to the first position, the second operating lever 500 is rotated to the third position, the operating portion is in the operation state, in this case, the operating portion composed of the first operating lever 200 and the second operating lever 500 is twisted to drive the first working portion 300 to rotate, so that the screws are able to be quickly disassembled, improving the disassembly efficiency of screws. Likewise, when assembling the screw, the force required for tightening the screw in the initial stage is small, in this case, the first operating lever 200 is able to be rotated to the first position, the second operating lever 500 is able to be rotated to the third position, and the operating portion formed by the first operating lever 200 and the second operating lever 500 is twisted to drive the first working portion 300 to rotate, so that the screws are able to be quickly tightened, and the efficiency of tightening the screw is improved. In the initial stage of loosening the screws or the final stage of tightening the screws, a large force is required, and in this case, the first operating lever 200 is rotated to the second position, and the second operating lever 500 is rotated to the fourth position, so that the operating portion is in the stowed state, and the user grips the handle 100 and applies a force to tighten or loosen the screws.

In some embodiments, when the first operating lever 200 is located at the first position and the second operating lever 500 is located at the third position, the first operating lever 200 is attached to the second operating lever 500, which enables a user to more quickly and conveniently twist the operating portion formed by the first operating lever 200 and the second operating lever 500, so as to drive the first working portion 300 to rotate, thereby quickly assembling and disassembling the screw, and improving the efficiency of assembling and disassembling the screw.

Certainly, in other embodiments, when the first operating lever 200 is located at the first position and the second operating lever 500 is located at the third position, the first operating lever 200 and the second operating lever 500 are able to be opposite to each other with an interval therebetween, or the first operating lever 200 and the second operating lever 500 form a V-shaped structure.

As shown in FIG. 5, in the present embodiment, a receiving groove 110 is provided on the side of the handle 100 away from the first working portion 300. A first end of the first operating lever 200 is rotatably connected with a side wall of a middle portion of the receiving groove 110 in a lengthwise direction, and when the first operating lever 200 is rotated to the second position, the first operating lever 200 is recessed into the receiving groove 110 located on the side of the first operating lever 200 away from the second operating lever 500. A first end of the second operating lever 500 is rotatably connected with the side wall of the middle portion of the receiving groove 110 in the lengthwise direction, and when the second operating lever 500 is rotated to the fourth position, the second operating lever 500 recessed into the receiving groove 110 located on the side of the second operating lever 500 away from the first operating lever 200. That is to say, as shown in FIG. 5, when the operating portion is in the stowed state, the first operating lever 200 and the second operating lever 500 are rotated to two sides into the receiving groove 110 at a corresponding side and recessed into the receiving groove 110. The operating portion is divided into two parts, which are rotated towards two sides respectively and recessed into the receiving groove 110, and this arrangement is able to reduce the depth of the receiving groove 110.

Other embodiments of the disclosure will be apparent to those skilled in the art from consideration of the specification and practice of the disclosure disclosed here. The present disclosure is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes can be made without departing from the scope thereof. It is intended that the scope of the disclosure only be limited by the appended claims.

1. A screw assembly and disassembly tool, comprising a handle, a first working portion and an operating portion; wherein
the first working portion is connected with the handle, and an end of the first working portion away from the handle is configured to cooperate with a slot of a screw head;
the operating portion is configured to have an operation state and a stowed state, the operating portion comprises a first operating lever, the first operating lever is connected with a side of the handle away from the first working portion, and the first operating lever is able to rotate at least between a first position and a second position;
the operating portion is configured such that in the operation state, the first operating lever is located at the first position, and the first operating lever is rotated to drive the first working portion to rotate; and when the operating portion is turned from the operation state to the stowed state, the first operating lever is rotated from the first position towards the handle, and is rotated to the second position.

2. The screw assembly and disassembly tool according to claim 1, wherein when the first operating lever is rotated to the first position, a lengthwise direction of the first operating lever is the same as an axial direction of the first working portion; and
when the first operating lever is rotated to the second position, an angle between the lengthwise direction of the first operating lever and the axial direction of the first working portion is 45° to 150°.

3. The screw assembly and disassembly tool according to claim 2, wherein the side of the handle away from the first working portion is provided with a receiving groove;
a first end of the first operating lever is rotatably connected with a side wall of the receiving groove, and when the first operating lever is rotated to the second position, the first operating lever is recessed into the receiving groove.

4. The screw assembly and disassembly tool according to claim 3, wherein the receiving groove comprises a transverse groove and a longitudinal groove communicated with each other, the transverse groove and the longitudinal groove form a T-shaped structure, and the longitudinal groove extends in the lengthwise direction of the handle;
the first operating lever comprises a connecting edge and an operating edge which are connected with each other; the operating edge and the connecting edge form a T-shaped structure; and the connecting edge is located inside the transverse groove and is rotatably connected with a side wall of the transverse groove;
when the first operating lever is rotated to the second position, the operating edge is rotated into the longitudinal groove; and
the lengthwise direction of the first operating lever is a lengthwise direction of the operating edge.

5. The screw assembly and disassembly tool according to claim 4, wherein a side surface of the operating edge is provided with an anti-slip structure.

6. The screw assembly and disassembly tool according to claim 3, wherein the side of the handle away from the first working portion is provided with an avoidance groove communicating with the receiving groove; and the avoidance groove is located at an end portion of the receiving groove away from its rotation connection point with the first operating lever;
the avoidance groove is configured such that when the first operating lever is rotated into the receiving groove, the avoidance groove provides space for a finger of a user, allowing the user to pry the first operating lever out of the receiving groove.

7. The screw assembly and disassembly tool according to claim 6, wherein an end surface of a second end of the first operating lever is provided with a finger-grip protrusion, and the second end of the first operating lever and the first end of the first operating lever are opposite ends of the first operating lever.

8. The screw assembly and disassembly tool according to claim 6, wherein a bottom surface of the avoidance groove is an inclined plane, and the inclined plane inclines towards a bottom of the receiving groove.

9. The screw assembly and disassembly tool according to claim 1, wherein the operating portion further comprises a second operating lever, the second operating lever is connected with the side of the handle away from the first working portion, and the second operating lever is rotatable at least between a third position and a fourth position;
the operating portion is configured such that in the operation state, the second operating lever is located at the third position, and the first operating lever and the second operating lever are rotated to drive the first working portion to rotate; when the operating portion is rotated from the operation state to the stowed state, the second operating lever is rotated from the third position towards the handle, and is rotated to the fourth position, and a direction in which the first operating lever is rotated from the first position to the second position is different from a direction in which the second operating lever is rotated from the third position to the fourth position.

10. The screw assembly and disassembly tool according to claim 9, wherein when the second operating lever is rotated to the third position, a lengthwise direction of the second operating lever is the same as an axial direction of the first working portion; and
when the second operating lever is rotated to the second position, an angle between the lengthwise direction of the second operating lever and the axial direction of the first working portion is 45° to 150°.

11. The screw assembly and disassembly tool according to claim 10, wherein when the first operating lever is located at the first position and the second operating lever is located at the third position, the first operating lever is attached to the second operating lever.

12. The screw assembly and disassembly tool according to claim 11, wherein the side of the handle away from the first working portion is provided with a receiving groove;
a first end of the first operating lever is rotatably connected with a side wall of a middle portion of the receiving groove in a lengthwise direction, and when the first operating lever rotates to the second position, the first operating lever is recessed into the receiving groove located on the side of the first operating lever away from the second operating lever;
a first end of the second operating lever is rotatably connected with the side wall of the middle portion of the receiving groove in the lengthwise direction, and when the second operating lever rotates to the fourth position, the second operating lever is recessed into the receiving groove located on a side of the second operating lever away from the first operating lever.

13. The screw assembly and disassembly tool according to claim 1, wherein the screw assembly and disassembly tool further comprises a second working portion, the second working portion is connected with the handle, the second working portion extends out from an end of the handle in a lengthwise direction of the handle, and an end of the second working portion extending out of the handle is configured to cooperate with a slot of a screw head.

14. The screw assembly and disassembly tool according to claim 13, wherein when the first operating lever is rotated to the first position, a lengthwise direction of the first operating lever is the same as an axial direction of the first working portion; and
when the first operating lever is rotated to the second position, an angle between the lengthwise direction of the first operating lever and the axial direction of the first working portion is 45° to 150°.

15. The screw assembly and disassembly tool according to claim 14, wherein the side of the handle away from the first working portion is provided with a receiving groove;
a first end of the first operating lever is rotatably connected with a side wall of the receiving groove, and when the first operating lever is rotated to the second position, the first operating lever is recessed into the receiving groove.

16. The screw assembly and disassembly tool according to claim 15, wherein the receiving groove comprises a transverse groove and a longitudinal groove communicated with each other, the transverse groove and the longitudinal groove form a T-shaped structure, and the longitudinal groove extends in the lengthwise direction of the handle;
the first operating lever comprises a connecting edge and an operating edge which are connected with each other; the operating edge and the connecting edge form a T-shaped structure; and the connecting edge is located inside the transverse groove and is rotatably connected with a side wall of the transverse groove;
when the first operating lever is rotated to the second position, the operating edge is rotated into the longitudinal groove; and
the lengthwise direction of the first operating lever is a lengthwise direction of the operating edge.

17. The screw assembly and disassembly tool according to claim 16, wherein a side surface of the operating edge is provided with an anti-slip structure.

18. The screw assembly and disassembly tool according to claim 15, wherein the side of the handle away from the first working portion is provided with an avoidance groove communicating with the receiving groove; and the avoidance groove is located at an end portion of the receiving groove away from its rotation connection point with the first operating lever;
the avoidance groove is configured such that when the first operating lever is rotated into the receiving groove, the avoidance groove provides space for a finger of a user, allowing the user to pry the first operating lever out of the receiving groove.

19. The screw assembly and disassembly tool according to claim 18, wherein an end surface of a second end of the first operating lever is provided with a finger-grip protrusion, and the second end of the first operating lever and a first end of the first operating lever are opposite ends of the first operating lever.

20. The screw assembly and disassembly tool according to claim 18, wherein a bottom surface of the avoidance groove is an inclined plane, and the inclined plane inclines towards a bottom of the receiving groove.
